(19) United States
(12) Patent Application Publication
(10) Pub. No.: US 2017/0092079 A1
(43) Pub. Date: Mar. 30, 2017

(54) GAMING SYSTEM AND A METHOD OF GAMING

(71) Applicant: Aristocrat Technologies Australia Pty Limited, North Ryde (AU)

(72) Inventor: Daniel Marks, Decatur, GA (US)

(21) Appl. No.: 15/274,808

(22) Filed: Sep. 23, 2016

Related U.S. Application Data
(60) Provisional application No. 62/233,048, filed on Sep. 25, 2015.

(51) Int. Cl. G07F 17/34; G07F 17/32

(52) U.S. Cl. CPC G07F 17/34; G07F 17/3213; G07F 17/3209; G07F 17/3246; G07F 17/3225; G07F 17/3251

(57) ABSTRACT

A gaming system comprising an ante bet selector arranged to facilitate selection by a player of an ante bet amount, a symbol selector arranged to select a plurality of symbols from a set of symbols for display in a plurality of display position groups, each display position group comprising a plurality of display positions, and the display position groups defining a plurality of rows and a plurality of columns, the number of rows defined by the display position groups being dependent on the ante bet amount selected by the player, an outcome evaluator arranged to determine whether the displayed symbols define a winning outcome, and a prize allocator arranged to allocate a prize when a winning outcome is displayed.

### RELATED APPLICATIONS

This application claims priority to U.S. Provisional Patent Application No. 62/233,048 having a filing date of Sep. 25, 2015, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

It is known to provide a gaming system arranged to randomly display several symbols from a predetermined set of symbols and to determine a game outcome such as a game win based on the displayed symbols.

Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming.

### BRIEF SUMMARY OF THE INVENTION

In accordance with a first aspect of the present invention, there is provided a gaming system comprising:

an ante bet selector arranged to facilitate selection by a player of an ante bet amount;

a symbol selector arranged to select a plurality of symbols from a set of symbols for display in a plurality of display position groups, each display position group comprising a plurality of display positions, and the display position groups defining a plurality of rows and a plurality of columns, the number of rows defined by the display position groups being dependent on the ante bet amount selected by the player;

an outcome evaluator arranged to determine whether the displayed symbols define a winning outcome; and

a prize allocator arranged to allocate a prize when a winning outcome is displayed.

Each display position group may be associated with a reel having a plurality of display positions, each reel defining a column of display position groups.

In an embodiment, a zero ante bet amount may correspond to three rows of display positions, a first ante bet amount may correspond to four rows of display positions, a second ante bet amount that is larger than the first ante bet amount may correspond to five rows of display positions, and a third ante bet amount that is larger than the second ante bet amount may correspond to five rows of display positions.

In an embodiment, the ante bet selected also determines the number of win lines that are used in the base game to determine win outcomes. For example, the number of win lines may increase with increasing ante bet amount.

In an embodiment, each ante bet selection may also correspond to a different return to player (RTP) amount.

The gaming system may be operable in base game mode or special game mode, wherein:

in base game mode, the gaming system implements a base game with the number of rows defined by the display position groups dependent on the ante bet amount selected by the player; and

in special game mode wherein at least one feature game different to the base game is implemented.

In one embodiment, the gaming system is arranged to commence special game mode when a trigger condition occurs.

In one embodiment, the gaming system is arranged to commence special game mode in response to player input, based on the amount or type of bet placed, or when a special game is purchased by a player.

The trigger condition may be display of a particular symbol, or display of a defined symbol combination during a base game.

In an embodiment, the system includes a plurality of selectable feature games.

The system may be arranged to randomly select a feature game from the plurality of feature games when the trigger condition occurs.

The system may be arranged to select a feature game from the plurality of feature games when the trigger condition occurs based on the trigger condition.

In accordance with a second aspect of the present invention, there is provided a method of playing a game comprising the steps of:

facilitating selection by a player of an ante bet amount;

selecting a plurality of symbols from a set of symbols for display in a plurality of display position groups, each display position group comprising a plurality of display positions, and the display position groups defining a plurality of rows and a plurality of columns, the number of rows defined by the display position groups being dependent on the ante bet amount selected by the player;

determining whether the displayed symbols define a winning outcome; and

allocating a prize when a winning outcome is displayed.

In accordance with a third aspect of the present invention, there is provided a tangible computer readable medium having a computer readable program code embodied therein for causing a computer to operate in accordance with the gaming system of the first aspect.

### BRIEF DESCRIPTION OF SEVERAL VIEWS OF THE DRAWINGS

In order that the present invention may be more clearly ascertained, embodiments of the present invention will now be described, by way of example only, with reference to the accompanying drawings, in which:

FIG. 1 is a schematic block diagram of components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a standalone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention wherein the gaming system is implemented over a network;

FIG. 7 is a flow diagram illustrating a method of gaming in accordance with an embodiment of the present invention; and

FIGS. 8 to 14 are diagrammatic representations of screens displayed by a gaming system in accordance with an embodiment of the present invention.

### DETAILED DESCRIPTION OF THE INVENTION

The present gaming system operates such that during play of a base game, a plurality of symbols are randomly selected from a set of symbols and displayed in a corresponding plurality of display position groups, each of which comprises a plurality of display positions. The symbols shown at the display positions are used to determine game outcomes by comparing the displayed symbols with defined winning combinations.

In one conventional type of gaming machine, a display area including 15 display positions is presented to a player with each display position including one symbol. The display positions are arranged in five vertically disposed reels that define three rows, with each reel corresponding with a display position group, and each reel having three visible display positions. After the reels are spun and subsequently stopped, the display positions show a random selection of symbols.

Generally, with such games, a plurality of win patterns in the form of win lines are defined which extend across the reels and include one display position from each reel. Typically the symbols that are disposed in a win line are compared with winning symbol combinations defined in a pay table so as to determine whether a player of the game should receive an award. For example, if winning symbol combinations are based on poker hands, a particular prize would be awarded if the win line comprises four aces. Other winning symbol combinations and corresponding prizes may also be defined.

Such a game often comprises normal game mode and special game mode. During normal game mode, the displayed symbols are compared with base winning combinations defined in a pay table.

With the present system, during special game mode, the gaming system is arranged to implement a feature game that is selected, for example pseudo randomly, from a plurality of available feature games.

The present system is also arranged such that prior to implementing a base game, a player selects the number of rows of display positions in the display area by selecting an ante bet amount. The ante bet amount may be selected using dedicated physical buttons or using a touch screen, and the ante bet amount will typically increase according to the number of desired rows. For example, the ante bet amount may be zero for three rows of display positions, a first amount of credits for four rows of display positions, a second amount of credits that is larger than the first amount of credits for five rows of display positions, and a third amount of credits that is larger than the second amount of credits for six rows of display positions.

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. The system is of the type including multiple game modes, such as being operable in normal game mode wherein a base game is implemented and special game mode wherein a feature game is implemented, and including an ante bet component.

With some such probabilistic games, the set of symbols used during normal game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

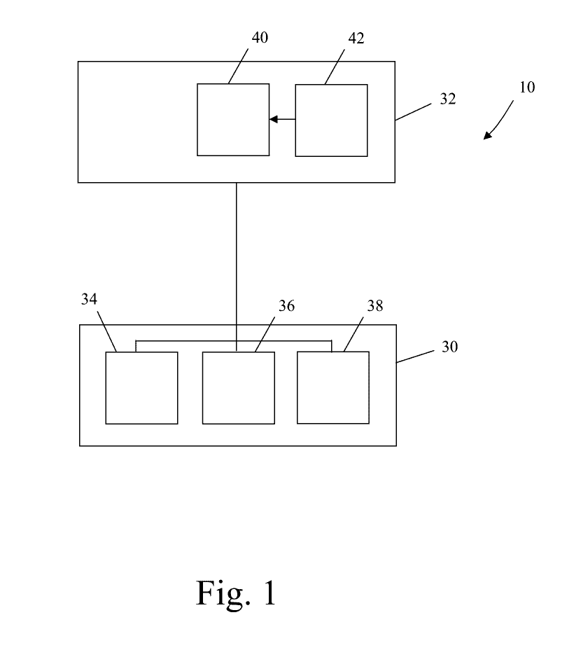

Referring to FIG. 1, a schematic diagram of components of a gaming system 10 in accordance with the present embodiment is shown. The components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, and a game play mechanism 38 arranged to enable a player to input game play instructions, including instructions during game play and ante bet selections prior to game play.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

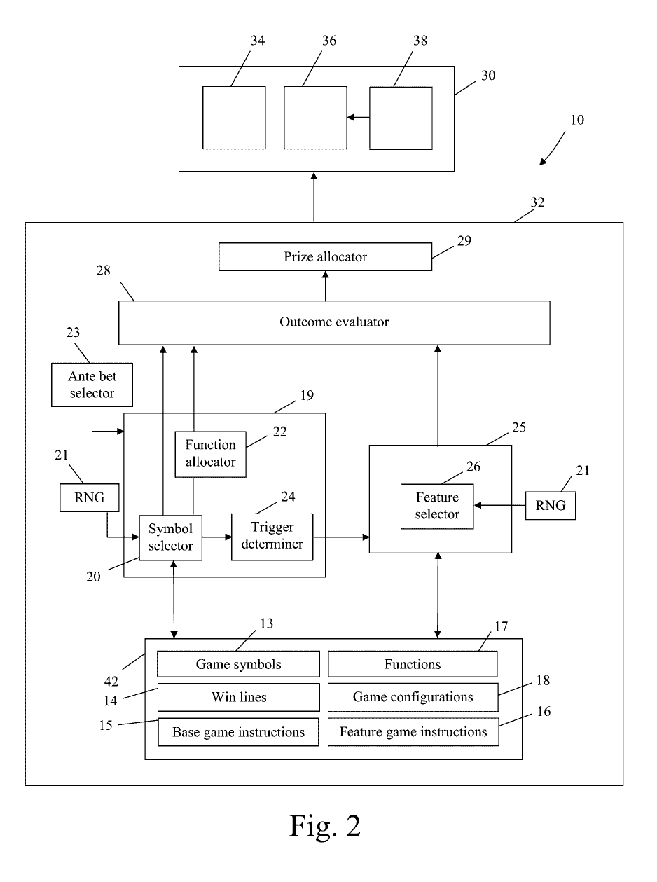

A functional diagram illustrating operative components of the game controller 32 is shown in FIG. 2.

The memory 42 is arranged to store symbols data 13 indicative of a plurality of symbols, in the present example associated with a plurality of reels, win lines data 14 indicative of available win lines, base game instruction data 15 indicative of base game instructions usable by the gaming machine 10 to control operation of the base game, feature game instruction data 16 indicative of feature game instructions usable by the gaming machine 10 to control operation of the feature games, functions data 17 indicative of functions applicable during a base game and/or a feature game, and game configuration data 18 indicative of available configurations for the display positions that are selectable by selecting an ante bet amount.

The game controller 32 includes a base game implementer 19 arranged to implement a base game, the base game implementer 19 having a symbol selector 20 which is arranged to select several symbols from the available symbols 14 for display to a player in a plurality of display positions, in this example by spinning reels containing the symbols and stopping the reels so as to display at least one symbol on each reel. In this example, the selection carried out by the symbol selector 20 is made using a random number generator 21.

It will be appreciated that the random number generator 21 may be of a type which is arranged to generate pseudo random numbers based on a seed number, and that in this specification the term “random” will be understood accordingly to mean truly random or pseudo random.

The game controller 32 also includes an ante bet selector 23 arranged to facilitate selection by a player of an ante bet amount prior to implementation of a base game and thereby selection of the number of rows of display positions to use in the base game.

With this embodiment, the game controller 32 also comprises a trigger determiner 24 arranged to determine whether a trigger condition exists and to commence a feature game when a trigger condition is determined to exist.

In order to implement a feature game, the game controller 32 includes a feature game implementer 25. In this example, multiple feature games are available to a player in response to a trigger condition. The feature game implementer 25 includes a feature selector 26 arranged to facilitate selection, in this example pseudo randomly using the random number generator 21, of one of a plurality of feature games defined by the feature game instructions 16.

During a feature game, a different game to the base game is implemented. In this example, the available feature games may include a first feature game wherein a jackpot amount is awarded to a player based on defined criteria, such as selection of a plurality of concealed items and a determination as to whether the selected items correspond to a jackpot bonus and the level of bonus that the selected items correspond to; a second feature game wherein a player is prompted to select one of several, for example two, items and a prize is awarded, such as an award of a defined number of credits or a defined number of free games, or an opportunity to play a jackpot feature according to the first feature game; or a third feature game wherein a bonus wheel spins and subsequently stops to select a prize, which may be an award of a defined number of credits or a defined number of free games, or an opportunity to play a jackpot feature according to the first feature game.

The game controller 32 also comprises an outcome evaluator 28 which, in accordance with the base game instructions 15, determines game outcomes based on the symbols selected for display to the player by the symbol selector 20 and, during a feature game, based on the specifications of the feature games defined by the feature game instructions 16.

The game controller 32 also comprises a prize allocator 29 arranged to allocate a prize to a player when a winning outcome exists.

In this example, the gaming system is operable in normal game mode and special game mode.

During normal game mode, a base game is implemented and the outcome evaluator 28 determines whether a standard winning symbol combination exists and a prize is awarded to a player for a standard winning symbol combination. The number of rows of symbol positions used during the base game is determined according to the ante bet selected by the player using the ante bet selector 23 prior to commencement of the base game.

During special game mode, a feature game is implemented, with the specification of the feature game determined according to which of the available plurality of feature games is selected by the feature selector 26.

In the embodiment described below, the symbol selector 20, the function allocator 22, the ante bet selector 23, the trigger determiner 24, the feature selector 26, the outcome evaluator 28, and the prize allocator 29 are at least partly implemented using the processor 40 and associated software although it will be understood that other implementations are envisaged.

The gaming system 10 can take a number of different forms.

In a first form, a player operable gaming device in the form of a stand alone gaming machine is provided wherein all or most components required for implementing the game are present in the gaming machine.

In a second form, a distributed architecture is provided wherein some of the components required for implementing the game are present in a player operable gaming device and some of the components required for implementing the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a device server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

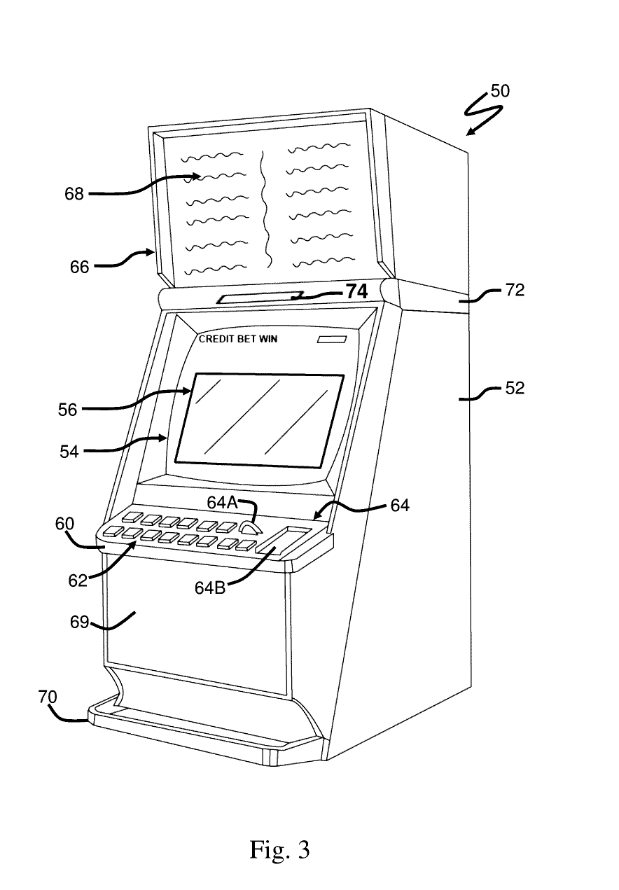

A gaming system in the form of a standalone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may comprise a touch screen usable by a player to interact with the gaming machine, in particular during game play.

The display 54 in this example is arranged to display representations of several reels, each reel of which has several associated symbols. Typically three, four or five reels are provided. During operation of the game, the reels first appear to rotate then stop with three, four or five symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

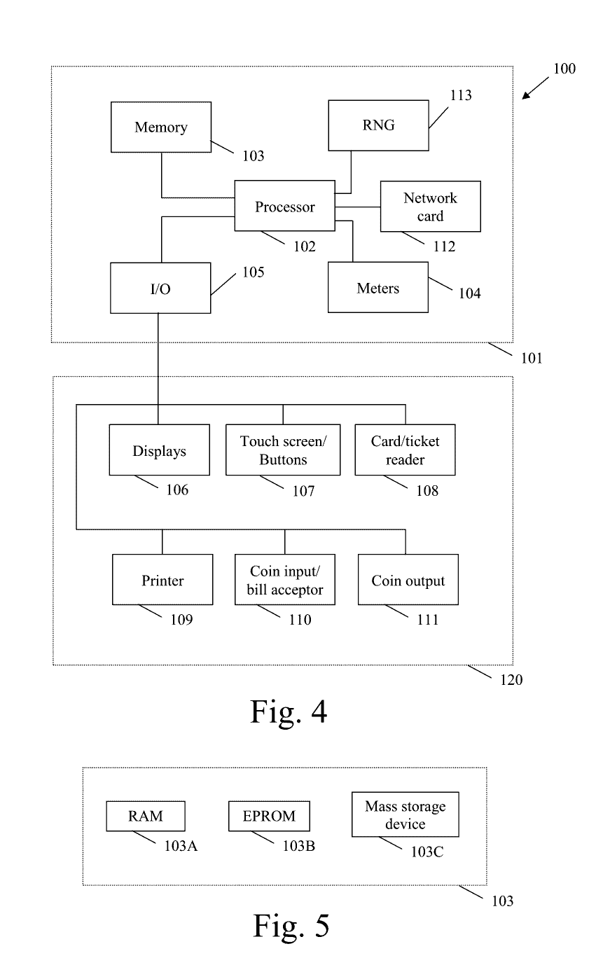

FIG. 4 shows a block diagram of operative components of a gaming device 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106, 107, 108, 109, 110, 111 may be provided remotely from the game controller 101.

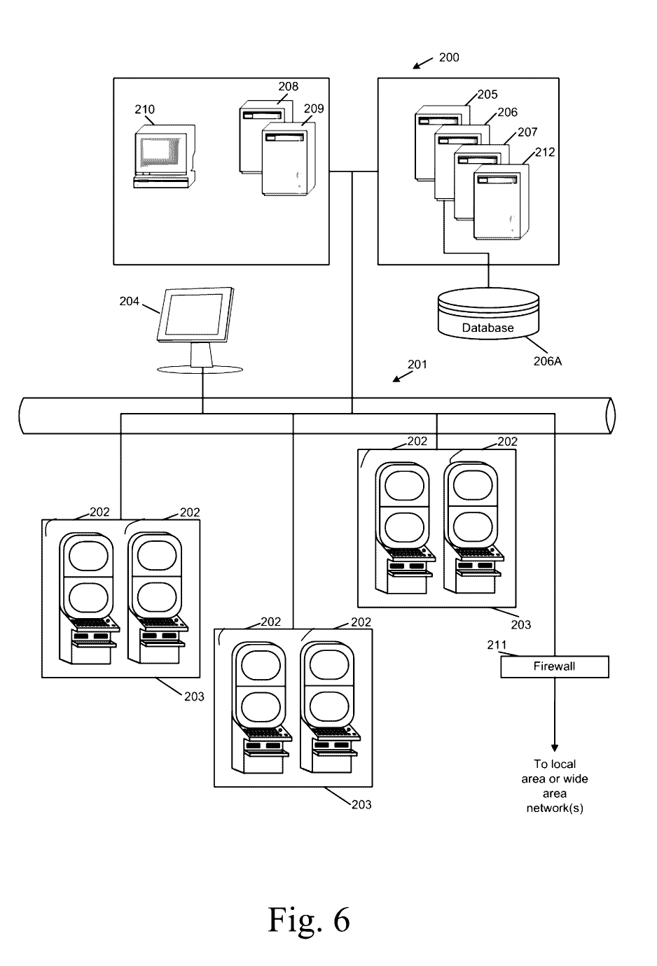

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40, 100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

Examples of specific implementations of the gaming system will now be described in relation to a standalone gaming machine 50 although it will be understood that implementation may also be carried out using other gaming system architectures such as a network architecture of the type shown in FIG. 6.

In this example, the gaming system comprises five reels, each reel corresponding to a display position group having an associated set of display positions for displaying symbols, and the display position configurations include three, four, five or six rows of display positions that are selectable by a player selecting a respective ante bet amount.

The reels are arranged during a base game to display standard symbols and one or more function symbols, and win outcomes are determined on the basis of the symbols visible at the display positions when the reels stop rotating.

Prior to commencement of base game play, a player selects the desired ante bet amount using the ante bet selector 23, which defines the number of rows that will be used in the base game. For example, the ante bet amount may be zero for three rows of display positions, a first amount of credits for four rows of display positions, a second amount of credits that is larger than the first amount of credits for five rows of display positions, and a third amount of credits that is larger than the second amount of credits for six rows of display positions.

Typically, a player will also purchase or otherwise obtain win entitlements such as several win lines which are used in the game to determine win outcomes. If the displayed symbols on the reels have symbols associated with a winning combination such as a winning combination disposed on a win line, the player wins a prize.

The ante bet selected may also determine the number of win lines that are used in the base game to determine win outcomes. For example, if no ante bet is selected, 15 lines may be provided, if a first level ante bet is selected, 30 lines may be provided, if a second level ante bet is selected, 45 lines may be provided, and if a third level ante bet is selected, 60 lines may be provided. Each ante bet selection and associated number of win lines may also correspond to a different return to player (RTP). For example, if no ante bet is selected, the RTP may be 88.94%, if a first level ante bet is selected, the RTP may be 90.31%, if a second level ante bet is selected, the RTP may be 92.16%, and if a third level ante bet is selected, the RTP may be 91.36%.

The gaming system is operable in normal game mode and special game mode and may be arranged to commence special game mode when a predetermined game outcome occurs. Special game mode may comprise one or more free games. Special game mode may commence automatically on the basis of a game event occurring during a game such as display of a particular symbol, based on game outcomes determined by the gaming system, or may be prompted by a player pressing a button on the gaming system 10 after the player has identified that a game outcome corresponding to special game mode requirements has occurred.

The gaming system 10 may also be arranged so as to determine eligibility for special game mode, for example based on the amount or type of bet placed, based on particular time periods and so on.

Special game mode may also be arranged to commence when a special game is purchased by a player.

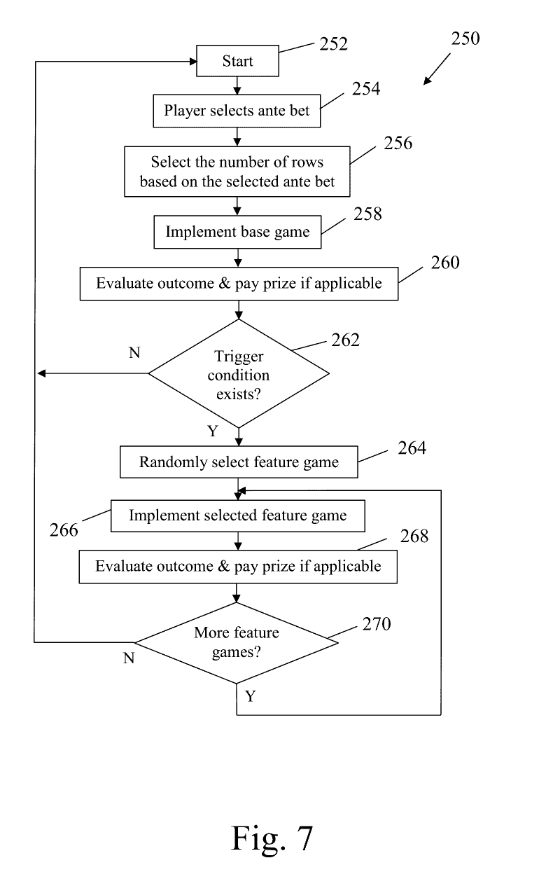

A specific example will now be described in relation to flow diagram 250 shown in FIG. 7 which illustrates steps 252 to 270 of a method of gaming implemented by the gaming system according to the present embodiment.

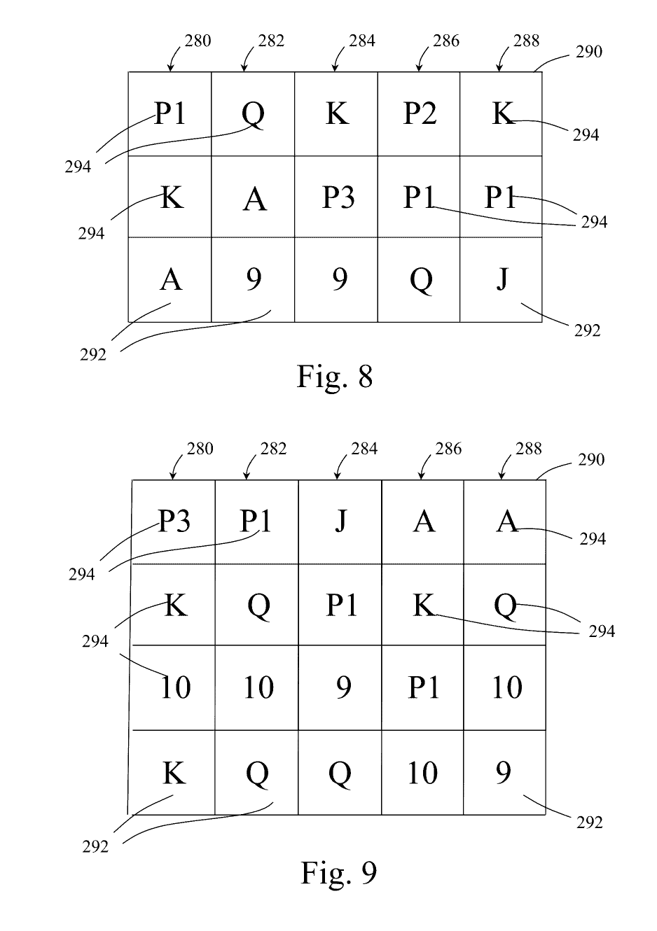

In this example, during a base game five virtual reels 280, 282, 284, 286, 288 are provided and displayed on a graphical display device 54 in a display area 290, as shown in FIG. 8. Each reel 280, 282, 284, 286, 288 corresponds to a display position group, and each reel comprises three, four or five display positions 292 for displaying symbols 294. In the example shown in FIG. 8, three display positions 292 are shown for each reel and therefore three rows of display positions are defined. It will be understood that any number of reels, and any number of rows may be provided.

Before implementation of a base game a player selects 254 the desired ante bet, and as a consequence a defined number of rows of symbol display positions are defined 256. The base game is then implemented 258 by spinning and subsequently stopping the reels to show a plurality of symbols 294 in the display area 290. The displayed symbols are evaluated 260 and prizes awarded according to winning combinations of symbols 294 appearing in the display area 290.

Winning symbol combinations may include common poker game winning combinations such as three of a kind, four of a kind, straights, flushes etc. A standard symbol winning combination may be achieved if symbols that form part of the standard winning combination are displayed at defined display positions on the reels.

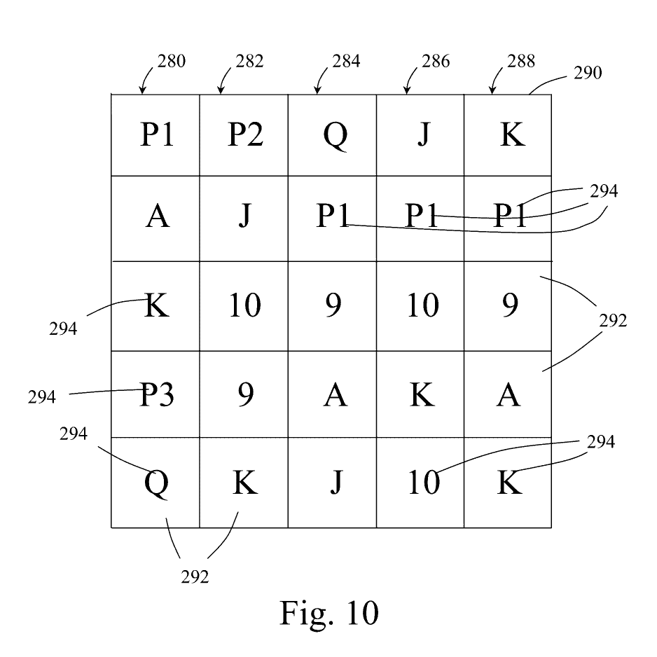

Example display areas 290 that include four or five rows are respectively shown in FIGS. 9 and 10.

If a trigger condition exists 262, special game mode commences which causes implementation of a feature game.

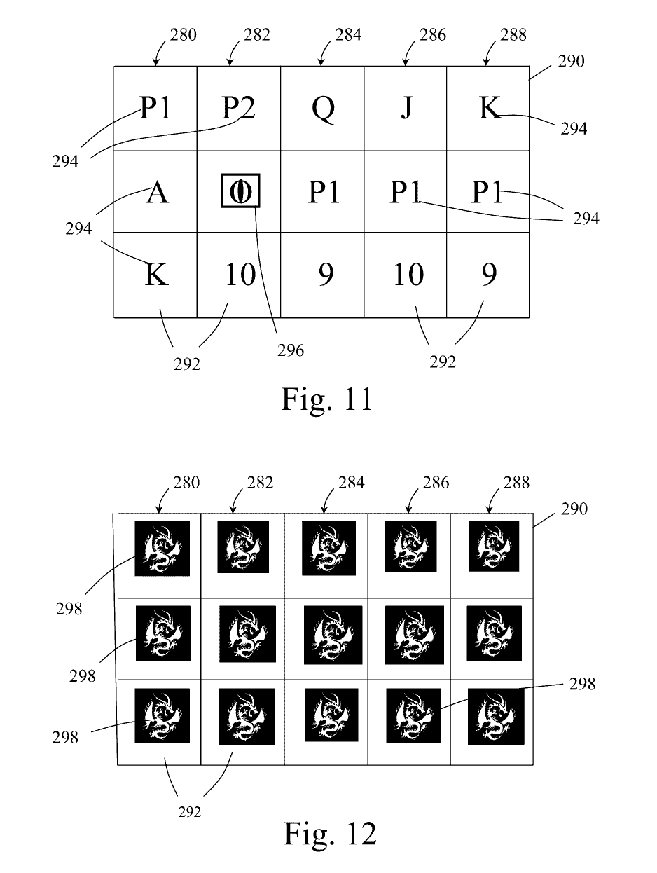

In this embodiment, three feature games are available, and the system randomly selects 264 one of the feature games. The selected feature game may include one or more individual games. In the example illustrated in FIG. 11, the trigger condition 262 is display of a special ‘dragon's eye’ symbol 296.

An example first feature game is shown in FIG. 12. Like and similar features are indicated with like reference numerals.

During implementation of the first feature game, each display position displays a jackpot ‘dragon’ symbol 298. Each dragon symbol 298 is associated with a jackpot type, in this example mini, minor, maxi, major or grand that correspond to progressively increasing jackpot amounts. The player is directed to select successive dragon symbols 298 until three of the same jackpot type have been selected. When this occurs, the player is awarded the jackpot amount corresponding to the jackpot type.

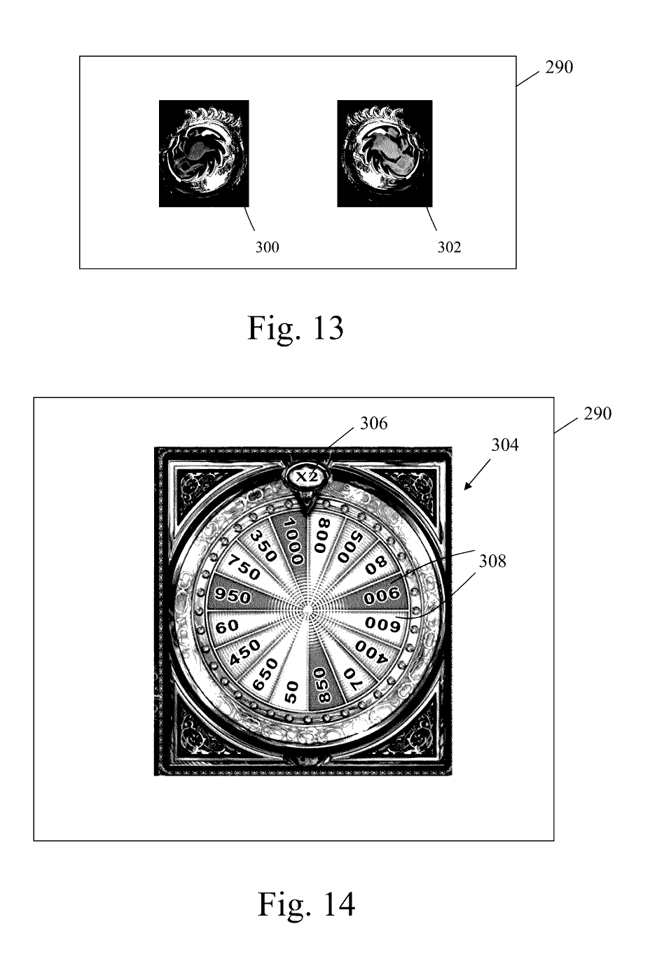

An example second feature game is shown in FIG. 13. Like and similar features are indicated with like reference numerals.

During implementation of the second feature game, a player is prompted to select one of several, for example two, feature ‘amulet’ symbols 300, 302 and a prize is awarded according to the amulet symbol 300, 302 selected. In this example, the prizes may include an award of a defined number of credits or a defined number of free games, or an opportunity to play a jackpot feature according to the first feature game.

An example third feature game is shown in FIG. 14. Like and similar features are indicated with like reference numerals.

During implementation of the third feature game, a bonus wheel 304 that includes a selector 306 and multiple available prizes 308 spins and subsequently stops to select a prize, which may be an award of a defined number of credits or a defined number of free games, or an opportunity to play a jackpot feature according to the first feature game.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

Modifications and variations as would be apparent to a skilled addressee are determined to be within the scope of the present invention.

1. A gaming system comprising:
a credit input mechanism configured for player interaction to receive a credit input in the form of a physical item representing a monetary value for establishing a credit balance;
an ante bet selector configured to facilitate selection by a player of an ante bet amount, in accord with said credit balance;
a display having a plurality of display position groups, each display position group comprising a plurality of display positions, and the display position groups defining a plurality of rows and a plurality of columns, the number of rows defined by the display position groups being dependent on the ante bet amount selected by the player;
a symbol selector configured to select a plurality of symbols from a set of symbols for display in the plurality of display position groups;
an outcome evaluator configured to determine whether the displayed symbols define a winning outcome; and
a prize allocator configured to allocate a prize when a winning outcome is displayed.

2. A gaming system as claimed in claim 1, wherein each display position group is associated with a reel having a plurality of display positions, each reel defining a column of display position groups.

3. A gaming system as claimed in claim 1, wherein the ante bet selected determines the number of win lines that are used in the base game to determine win outcomes.

4. A gaming system as claimed in claim 3, wherein the number of win lines increases with increasing ante bet amount.

5. A gaming system as claimed in claim 1, wherein each ante bet selection corresponds to a different return to player (RTP) amount.

6. A gaming system as claimed in claim 1, wherein a zero ante bet amount corresponds to three rows of display positions, a first ante bet amount corresponds to four rows of display positions, a second ante bet amount that is larger than the first ante bet amount corresponds to five rows of display positions, and a third ante bet amount that is larger than the second ante bet amount corresponds to five rows of display positions.

7. A gaming system as claimed in claim 1, wherein the gaming system is operable in base game mode or special game mode, wherein:
in base game mode, the gaming system implements a base game with the number of rows defined by the display position groups dependent on the ante bet amount selected by the player; and
in special game mode wherein at least one feature game different to the base game is implemented.

8. A gaming system as claimed in claim 7, wherein the gaming system is configured to commence special game mode when a trigger condition occurs.

9. A gaming system as claimed in claim 7, wherein the gaming system is configured to commence special game mode in response to player input, based on the amount or type of bet placed, or when a special game is purchased by a player.

10. A gaming system as claimed in claim 8, wherein the trigger condition is at least one of a display of a particular symbol, and a display of a defined symbol combination during a base game.

11. A gaming system as claimed in claim 7, wherein the system includes a plurality of selectable feature games.

12. A gaming system as claimed in claim 11, wherein the system is configured to randomly select a feature game from the plurality of feature games when the trigger condition occurs.

13. A gaming system as claimed in claim 11, wherein the system is configured to select a feature game from the plurality of feature games based on the trigger condition.

14. A method of playing a game on a gaming machine having a credit input mechanism configured to receive a physical item associated with a monetary value for establishing a credit balance, the credit balance being increasable and decreasable based at least on wagering activity, a player interface, a display having a plurality of display position groups, each display position group comprising a plurality of display positions, and the display position groups defining a plurality of rows and a plurality of columns, and a game controller, the method comprising:
establishing a credit balance via said credit input mechanism receiving a physical item;
facilitating, via the player interface, a selection of an ante bet amount, in accord with said credit balance;
defining, via the game controller, the number of rows in the plurality of display position groups based on the ante bet amount selected;
selecting, via the game controller, a plurality of symbols from a set of symbols for display in the defined number of rows of display positions;
displaying at the defined number of rows of display positions the selected symbols;
determining, via the game controller, whether the displayed symbols define a winning outcome; and
allocating a prize when a winning outcome is displayed.

15. A tangible computer readable medium having a computer readable program code embodied therein for causing a computer to operate in accordance with the gaming system as claimed in claim 1.
